(19) United States
(12) Patent Application Publication
(10) Pub. No.: US 2004/0097357 A1
(43) Pub. Date: May 20, 2004

(54) Techniques for making mono-axially oriented draw tape which is usable in a draw tape bag

(75) Inventors: Todd Pihl, Uxbridge, MA (US); John P. Gagnon, Franklin, MA (US); Michael Quarrey, North Grafton, MA (US)

Correspondence Address: David E. Huang, Esq., CHAPIN & HUANG, L.L.C., Westborough Office Park, 1700 West Park Drive, Westborough, MA, 01581, US

(73) Assignee: FilmX, Inc., Dayville, CT (US)

(21) Appl. No.: 10/714,686

(22) Filed: Nov. 17, 2003

Related U.S. Application Data
(62) Division of application No. 09/977,464, filed on Oct. 15, 2001, now abandoned.

(51) Int. Cl. B31B 1/64

(52) U.S. Cl. 493/190; 383/75

(57) ABSTRACT

A technique involves making mono-axially oriented draw tape. The technique involves forming a solid sheet of thermoplastic material from molten thermoplastic material, and producing a set of draw tape feeds from the solid sheet of thermoplastic material. The technique further involves stretching and annealing the set of draw tape feeds to orient molecules within the set of draw tape feeds such that tensile strength of each draw tape feed is greater in a first direction than in a second direction which is substantially perpendicular to the first direction. As a result, the draw tape feeds are extremely strong in the first direction and well-suited for use in draw tape bags.

### BACKGROUND OF THE INVENTION

A typical draw tape bag (e.g., a trash bag) includes two panels of thermoplastic material and a pair of draw tape strips. The two panels join together on three sides, and fold over on a fourth side to form a pair of tubular hems at a top of the bag. The draw tape strips reside within the tubular hems and attach to the sides of the two panels. Access holes in the tubular hems expose the draw tape strips so that a user can pull the draw tape strips through the holes in order to close the top of the bag and carry the bag.

One conventional draw tape bag uses draw tape which is manufactured using a single-layer blown-film approach. In the single-layer blown-film approach, the draw tape manufacturer extrudes a blend of thermoplastic polymers into molten thermoplastic material, and forms a tube of the molten thermoplastic material. The manufacturer blows air into the tube to expand the tube in multiple directions (e.g., to expand the tube in both the horizontal and vertical directions to bi-axially orient molecules in the tube in both directions). The manufacturer then cuts the tube lengthwise to form one or more sheets of thermoplastic film. Next, the manufacturer cools the sheets and winds the sheets onto large rollers to form master rolls of thermoplastic film. In a secondary operation, the manufacturer unwinds the thermoplastic film from the master rolls, slits the thermoplastic film into individual draw tapes, and winds the individual draw tapes into individual pads or spools for subsequent use in draw tape bags.

In the single-layer blown-film approach, the manufacturer typically uses, as the blend of thermoplastic polymers, a mixture of high-density polyethylene (HDPE) and lower-density material such as linear low-density polyethylene (LLDPE), low-density polyethylene (LDPE), or ethyl vinyl acetate (EVA) (e.g., 80% HDPE and 20% LLDPE). The HDPE provides strength to the draw tape so that it is unlikely that the user will overstretch or break the draw tape when pulling on the draw tape. The lower-density material lowers the melting point of the draw tape so that a draw tape bag manufacturer can reliably attach the draw tape to the thermoplastic panels of the bag in a shorter period of time than if the manufacturer were to use a draw tape made entirely of HDPE (e.g., using a heat sealing process that requires less time and less heat than that which would be used for a draw tape consisting entirely of HDPE). The lower-density material also makes the draw tape softer for a more comfortable feel, i.e., more ergonomically appealing to a user's hand than draw tape made entirely from HDPE.

Another conventional draw tape bag uses multi-layer draw tape which is manufactured using a multi-layer blown-film extrusion approach. In the multi-layer blown-film extrusion approach, the draw tape manufacturer extrudes different materials through a complex die having multiple channels and multiple openings through which the different materials pass. In particular, the manufacturer (i) extrudes HDPE through a first channel and through a middle opening of the die, and (ii) extrudes a lower-density material such as LLDPE, LDPE, or EVA through a second channel and through two peripheral openings, one peripheral opening being on each side of the middle opening, to form a multi-layered sheet having a central core of high-density polyethylene and two outer layers of lower-density material. The manufacturer then cools the multi-layered sheet and winds the multi-layered sheet onto a large roller. Then, in a secondary operation, the manufacture unwinds the multi-layered sheet, slits the multi-layered sheet into individual draw tapes, and winds the individual draw tapes onto individual pads or spools for subsequent use in draw tape bags.

As in the multi-layer blown-film approach, the use of the HDPE (as the core) in the multi-layer extrusion approach provides strength to the draw tape so that it is unlikely that the user will overstretch or break the draw tape when pulling on the draw tape. The lower-density outer layers have lower melting points than the high-density polyethylene thus enabling a draw tape bag manufacturer to attach the draw tape to the thermoplastic panels of the bag in a shorter period of time and to use less heat than if the manufacturer were to use a draw tape made using the single-layer blown-film approach with material consisting predominantly of HDPE.

### SUMMARY OF THE INVENTION

Unfortunately, there are deficiencies to above-described conventional approaches to manufacturing draw tape. For example, in the earlier-described conventional single-layer blown-film approach, the draw tape is typically bi-axially oriented and thus does not achieve maximum strength in the lengthwise direction, i.e., along the length of the draw tape. As a result, some draw tapes made using the single-layer blown-film approach may stretch and/or break with a relatively small amount of force (e.g., less than 20 pounds of force). Additionally, the lengths of the draw tape made using the single-layer blown-film approach are limited by the length of the master rolls and such limited lengths place limitations on draw tape bag manufacturers. In particular, the draw tape manufacturer typically splices together individual draw tapes onto a single hub in order to provide a spool of draw tape longer than the length of a master roll. Such splices create potential points of weakness in the draw tape (i.e., points which are prone to failure). For instance, the draw tape may break when a user (e.g., a consumer) pulls on the draw tape in an attempt to close or lift a draw tape bag thus resulting in customer dissatisfaction. Also, the draw tape may break, stretch or snag in equipment during the draw tape bag manufacturing process thus resulting in costly production downtime and a waste of materials. Furthermore, the blown-film process is an inefficient use of resources since a significant amount of resources must be invested in winding the thermoplastic film onto large rollers to form master rolls shortly after the thermoplastic film is made and then, as a secondary procedure, unwinding the master rolls to cut the film into individual feeds and winding the feeds into pads or spools. In some cases, the cost for such resources (winding equipment, unwinding equipment, additional personnel, etc.) makes the blown-film approach prohibitively expensive.

Additionally, in the earlier-described conventional multi-layer blown-film extrusion approach, manufacturing of the multi-layer draw tape requires (i) handling different raw materials (e.g., HDPE and EVA) and (ii) using a complex die having multiple channels and multiple openings. Accordingly, the multi-layer draw tape resulting from the multi-layer blown-film extrusion approach can be substantially more expensive and more difficult to manufacture than a single-layer draw tape (e.g., draw tape made from the single-layer blown-film approach). Furthermore, a significant amount of time and heat is required to attach the multi-layered draw tape to the thermoplastic panels of the draw tape bag. In particular, each heat seal (i.e., the attachment point between the ends of two pieces of multi-layered draw tape and two folded-over thermoplastic panels forming tubular hems) requires heat to penetrate through a layer of high-density polyethylene (the core of each draw tape) in order to melt a lower-density layer and thermoplastic material on the opposite side of the draw tape. Such large amounts of time and heat result in an increase in cost per draw tape bag by limiting the utilization of the draw tape bag manufacturing equipment. Moreover, in the multi-layer blown-film extrusion approach to making draw tape, as in the single-layer blown-film approach, the draw tape is bi-axially oriented and thus does not achieve maximum strength in the lengthwise direction, i.e., along the length of the draw tape. As a result, some draw tapes made using the multi-layer blown-film approach may stretch and/or break with a relatively small amount of force (e.g., less than 20 pounds of force). Additionally, in the multi-layer blown-film extrusion approach to making draw tape, as in the single-layer blown-film approach, the lengths of the draw tape made using the multi-layer blown-film approach are limited by the length of the master rolls and such limited lengths place the same limitations (the need for splices, higher processing costs) on draw tape bag manufacturers using multi-layer blown-film draw tape as single-layer blown-film draw tape.

Embodiments of the invention are directed to techniques for making mono-axially oriented draw tape. Such techniques involve stretching and annealing a feed of draw tape to orient molecules within the draw tape feed such that tensile strength is greater in one direction (e.g., the lengthwise direction along the draw tape feed). By orienting the draw tape in one direction only, this method allows the manufacturer to make substantially stronger draw tape. Moreover, the manufacturer can use a lower-density material (e.g. LLDPE) and achieve equal or greater draw tape strength than conventional manufacturers using HPDE. The advantage of this is that lower-density materials require less heat and time to fasten to thermoplastic panels when manufacturing a draw tape bag.

One embodiment is directed to a method of making mono-axially oriented draw tape. The method includes the steps of forming a solid sheet (a thermoplastic web or film ranging in thickness between 0.001 and 0.010 inches) of thermoplastic material from molten thermoplastic material, and producing a set of draw tape feeds from the solid sheet of thermoplastic material. The method further includes the step of stretching and annealing the set of draw tape feeds to orient molecules within the set of draw tape feeds such that tensile strength of each draw tape feed is greater in a first direction than in a second direction which is substantially perpendicular to the first direction. As a result, the draw tape feeds are extremely strong in the first direction and are well-suited for use in draw tape bags.

In one arrangement, the molten thermoplastic material includes molten LLDPE. In this arrangement, the step of forming the solid sheet of thermoplastic material includes the step of cooling the molten LLDPE in a bath in order to form, as the solid sheet of thermoplastic material, a single solid layer of LLDPE. In one arrangement, the step of forming the solid sheet of thermoplastic material further includes the step of (prior to the step of cooling) extruding the molten LLDPE through a die that defines an elongated opening. The use of the die to form a single solid layer of LLDPE can provide a simpler and less expensive process than that for the conventional multi-layer extrusion approach which involves passing both HDPE and lower-density material through separate channels and openings of a more-complex die in order to generate a multi-layer draw tape.

In one arrangement, the step of stretching and annealing includes the step of passing the set of draw tape feeds through a series of rotating temperature-controlled rollers which are configured to stretch and anneal the set of draw tape feeds. The series of rotating temperature-controlled rollers includes, among other things, a first roller which is configured to rotate at a first rate and have a first temperature, and a second roller which is configured to rotate at a second rate that is different than the first rate and have a second temperature that is different than the first temperature. A combination of varied temperatures and speeds (e.g., elevated temperature and increased speed) results in stretching, orienting and annealing the draw tape. Such processing of the draw tape feeds strengthens the draw tape feeds in an organized and consistent manner.

In one arrangement, the step of producing the set of draw tape feeds includes the step of cutting the solid sheet of thermoplastic material along the first direction to produce, as the set of draw tape feeds, separate feeds of draw tape. This arrangement can then include a further step of simultaneously winding the separate feeds of draw tape onto respective hubs (e.g., cardboard cylinders) in order to simultaneously form multiple rolls of draw tape. Accordingly, multiple rolls of draw tape can be created in a contiguous manner thus alleviating the need for winding sheets into master rolls and, in a secondary procedure, subsequently unwinding the sheets, cutting the sheets into individual feeds and winding and splicing the feeds into pads or spools. Moreover, this arrangement of the invention is well-suited for making spools having extremely long draw tape lengths with no weak points (e.g., with no splice points) since there is no winding and unwinding sheets (i.e., there are no master rolls) which limit the feed lengths.

The features of the invention, as described above, may be employed in manufacturing systems and methods for making mono-axially oriented draw tape, the tape itself, and various systems, products and methods which use such tape, such as those of Film X, Inc. of Dayville, Conn.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a draw tape manufacturing system which is suitable for use by the invention.

FIG. 2 is a diagram of various materials which are used and/or provided by the draw tape manufacturing system of FIG. 1.

FIG. 3 is a perspective view of an extruder die of the draw tape manufacturing system of FIG. 1.

FIG. 4 is a block diagram of a portion of an orientating assembly of the draw tape manufacturing system of FIG. 1.

FIG. 5 is a block diagram of a portion of a draw tape feed which is input into the portion of the orientating assembly of FIG. 4.

FIG. 6 is a block diagram of the portion of the draw tape feed when output from the portion of the orientating assembly of FIG. 4.

FIG. 7 is a flowchart of a procedure which is performed by the draw tape manufacturing system of FIG. 1.

FIG. 8 is a block diagram of a draw tape bag manufacturing system which is suitable for use by the invention.

FIG. 9 is a flowchart of a procedure which is performed by the draw tape bag manufacturing system of FIG. 8.

FIG. 10 is a perspective view of a draw tape bag produced by the draw tape bag manufacturing system of FIG. 8.

### DETAILED DESCRIPTION

Embodiments of the invention are directed to techniques for making mono-axially oriented draw tape which is useful in certain applications such as in draw tape bags. Such techniques involve stretching and annealing a feed of draw tape to orient molecules within the draw tape feed such that the tensile strength of the draw tape feed is greater in a particular direction (e.g., a direction along the draw tape feed). Accordingly, a manufacturer use certain materials (e.g., LLDPE) to fabricate a draw tape which requires less heat and time to fasten to thermoplastic panels than conventional draw tapes (e.g., a single-layer draw tape consisting of a blend of 20% LLDPE and 80% high-density polyethylene, a multi-layer draw tape having an HDPE core, etc.) when manufacturing a draw tape bag, but which still provides strength that is equal to or greater than a conventional draw tape in a particular direction (e.g., the direction along the draw tape feed).

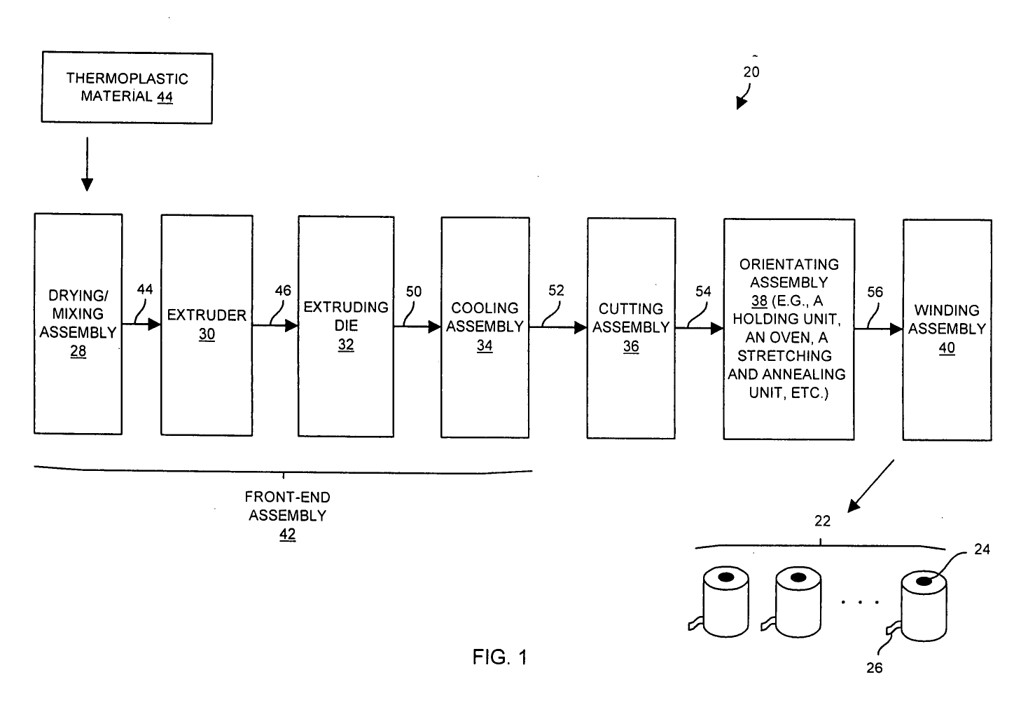

FIG. 1 shows a mono-axially oriented draw tape manufacturing system 20 which is suitable for use by the invention. The mono-axially oriented draw tape manufacturing system 20 is capable of simultaneously making multiple rolls 22 of mono-axially oriented draw tape. Each roll 22 includes an inner hub 24 (e.g., a cardboard tube, cylinder, etc.) and a length of draw tape 26.

As shown in FIG. 1, the mono-axially oriented draw tape manufacturing system 20 includes a drying/mixing assembly 28, an extruder 30, an extruding die 32, a cooling assembly 34 (e.g., a bath), a cutting assembly 36, an orientating assembly 38 (e.g., a holding unit, a heating unit, a stretching unit, and annealing unit), and a winding assembly 40. The drying/mixing assembly 28, the extruder 30, the extruding die 32 and the cooling assembly 34 form a front-end assembly 42 of the system 20.

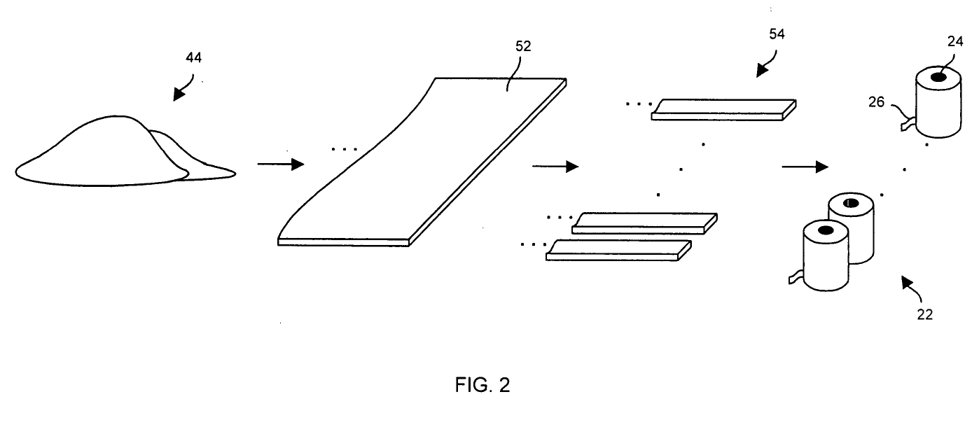

FIG. 2 shows various materials which are used and/or provided by the mono-axially oriented draw tape manufacturing system 20. As shown in both FIGS. 1 and 2, thermoplastic material 44 is a raw material which is use by the system 20. In one arrangement, the thermoplastic material 44 is LLDPE in a pelletized form.

The drying/mixing assembly 28 provides thermoplastic material 44 to the extruder 30 which further mixes the thermoplastic material 44. Moreover, the extruder 30 grinds and sheers the thermoplastic material 44 into the molten thermoplastic material 46, and pushes the molten thermoplastic material 46 through the extruding die 32 to form a molten sheet 50 (i.e., a liquid sheet) of thermoplastic material (see FIG. 1). To this end, a rotating screw of the extruder 30 generates friction and heat to melt the thermoplastic material 44 into the molten sheet 50 of thermoplastic material 46. It should be understood that the term sheet generally refers to a thermoplastic sheet, web, or film having a thickness between 0.001 and 0.010 inches.

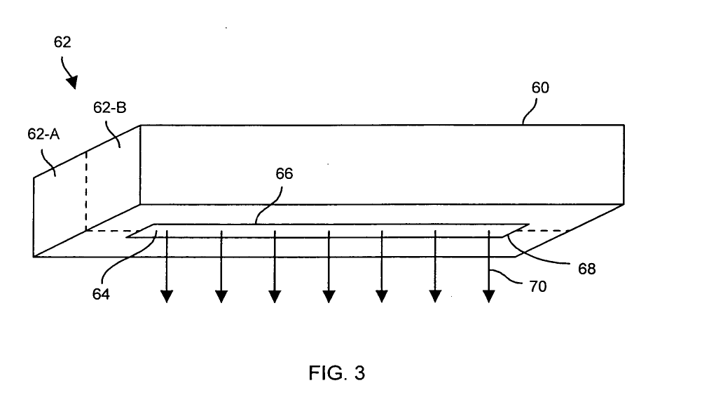

FIG. 3 shows a perspective view of a die 60 which is suitable for use as the extruding die 32. The die 60 includes a pair of side members 62 (i.e., a first side member 62-A and a second side member 62-B.) which fasten together to define an elongated opening 64. In one arrangement, the opening 64 has a length 66 and a width 68, with the length 66 being substantially greater than the width 68 in order to form the molten sheet 50. In one arrangement, the die 60 is located such that the elongated opening 64 points in a downward direction 70 such that the molten sheet 50 of thermoplastic material drops (e.g., due to gravity) into a liquid cooling bath of the cooling assembly 34 (FIG. 1).

The cooling assembly 34 cools the molten sheet 50 of thermoplastic material into a solid sheet 52 of thermoplastic material (also see FIG. 2). In one arrangement, the cooling assembly 34 includes a tank that holds the liquid cooling bath which receives the molten sheet 50 of thermoplastic material. When the molten sheet 50 travels through the cooling bath, the molten sheet 50 solidifies as its temperature drops. As the solid sheet 52 of thermoplastic material exits the liquid cooling bath of the cooling assembly 34, vacuum rollers of the cooling assembly 34 remove excess bath liquid from the solid sheet 52.

In an alternative arrangement, the cooling assembly 34 includes a set of chilled rollers (i.e., one or more chilled rollers) in place of the liquid cooling bath. In this arrangement, the molten sheet 50 of thermoplastic material is extruded onto and/or through the set of chilled rollers which cools and solidifies the molten sheet 50 (i.e., the molten sheet 50 solidifies into the hardened sheet 52 as its temperature drops).

Next, the cutting assembly 36 cuts the solid sheet 52 into multiple parallel feeds 54. In one arrangement, the cutting assembly 36 includes a row of blades mounted in fixed positions so that the resulting feeds 54 have defined (e.g., uniform) widths. An example range of widths for each feed 54 is between 0.125 to 2.000 inches. In another arrangement, the cutting assembly 36 includes a row of sheer blades which cut the solid sheet 52 into the multiple parallel feeds 54.

The orientating assembly 38 then brings the multiple parallel feeds 54 of draw tape into a finished state. In particular, the orientating assembly 38 stretches and anneals the multiple parallel feeds 54 to orient molecules within the feeds 54 such that the tensile strength of each feed 54 is greater in the lengthwise direction along the feed 54 than in the widthwise direction across the feed 54, the widthwise direction being substantially perpendicular to the lengthwise direction.

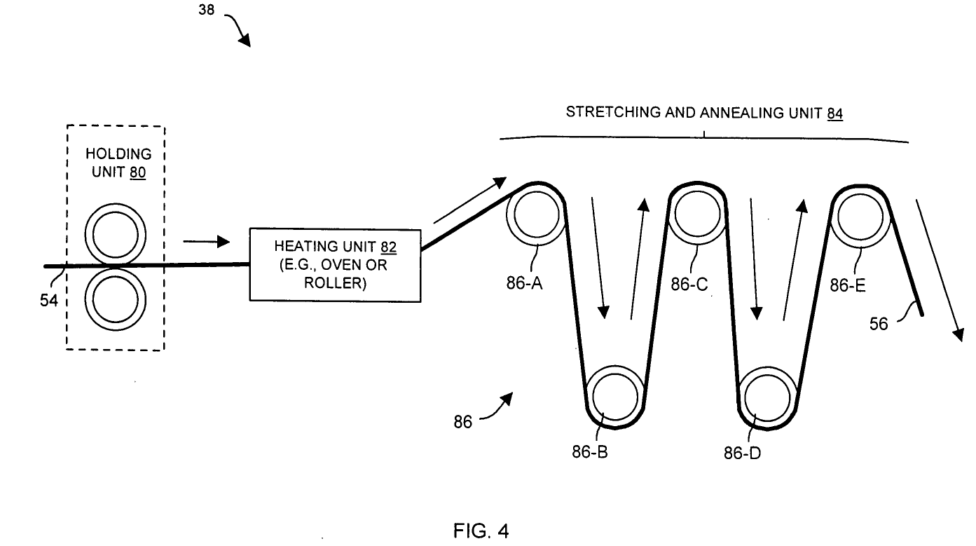

FIG. 4 shows a cross-sectional side view of suitable components for the orienting assembly 38 (also see FIG. 1). The orientating assembly 38 includes a holding unit 80, a heating unit 82 and a stretching and orientating unit 84. The holding unit 80 includes a set of rotating rollers which holds the multiple parallel feeds 54 of draw tape and allows the feeds 54 to pass through at a predetermined rate. The heating unit 82 (e.g., an oven, a set of heated rollers, etc.) raises the temperature of the multiple feeds 54 of draw tape. Next, rollers 86 of the stretching and annealing unit 84 draw the multiple parallel feeds 54 of draw tape. Some of the rollers 86 (e.g., rollers 86-A, 86-B, 80-C) rotate at a predetermined rate that is faster than the rate of the rollers of the holding unit 80. The combination of elevated temperatures and increased speed results in stretching the multiple parallel feeds 54 of draw tape in the lengthwise direction (i.e. the direction of movement of the feeds). This stretching orients the molecules in the lengthwise direction and maximizes the tensile strength of the draw tape in the lengthwise direction. This stretching and orienting also brings the multiple parallel feeds of draw tape 54 to a desired width and thickness (e.g. 0.0015, 0.00175, 0.002, 0.003 inches) and tensile strength (e.g. 26, 28, 30 pounds). The multiple parallel feeds 54 of draw tape next pass over other rollers which anneal the feeds of draw tape (e.g., rollers 80-D, 80-E). The annealing rollers use various speeds and temperatures to permanently set the orientation of the multiple parallel feeds of draw tape 54. The orienting assembly 38 strengthens the draw tape feeds 54 in an organized and consistent manner, and the resulting oriented and annealed draw tape feeds 56 exiting the orienting assembly 38 are well-suited for certain applications such as handles for draw tape bags.

It should be understood that circuitry within the orientating assembly 38 (e.g., a computer, sensors, cooling and/or heating elements, motors, etc.) operate so that the series of components provide the proper predetermined rotational speeds and temperatures. Accordingly, the feeds 54 are subjected to a consistent and uniform molecular orientating process. In one arrangement, the feeds 52 entering the orientating assembly 38 are feeds of single-layer LLDPE, and the feeds 54 exiting the orientating assembly 38 are feeds of oriented single-layer LLDPE.

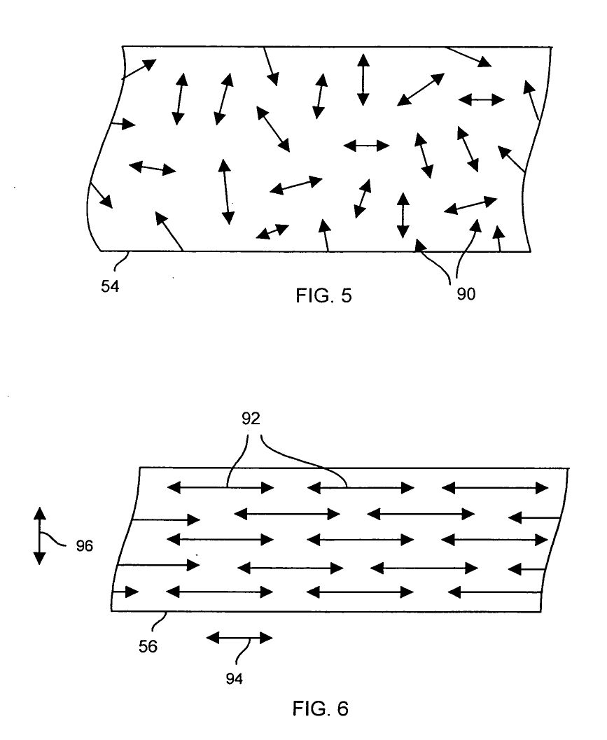

FIG. 5 is a top view of a portion of a draw tape feed 54 just prior to entering the orientating assembly 38. As shown by the arbitrarily oriented arrows 90, the molecules of the draw tape feed 54 have not been substantially oriented to provide strength in any particular direction. Rather, the molecules of the draw tape feed 54 are randomly oriented and thus providing fairly uniform tensile strength in all directions. That is, the molecules do not provide maximum strength in the lengthwise direction.

FIG. 6 is a top view of a portion of a draw tape feed 56 as it exits the orientating assembly 38. As shown by the oriented arrows 92, the molecules are no long randomly oriented. Rather, the molecules are now oriented to provide substantially greater tensile strength in the lengthwise direction 94, i.e., the direction of movement of the draw tape feed 56 through the system 20. As shown in FIG. 6, the lengthwise direction 94 is substantially perpendicular to the widthwise direction 96 across the draw tape feed 56. In one arrangement, the draw tape feed 56 is thinner than the draw tape feed 54 and is stretched approximately 2.8 times the length of the draw tape feed 54 (i.e., the draw tape feed 56 is longer than the draw tape feed 54 by a 2.8 to 1.0 ratio).

Next, the winding assembly 40 (see FIG. 1) winds the multiple feeds 56 exiting the orientating assembly 38 onto hubs 24 to form multiple rolls 22 of mono-axially oriented draw tape. The feeds 56 extend in a side-by-side manner from the orientating assembly 38 to the winding assembly 40. In one arrangement, each feed 56 passes through a series of eyelets which guide the feeds 56 onto a respective winder of the winding assembly 40 and a respective hub 24. In one arrangement, the feeds 56 of draw tape roll onto hubs 24 which are substantially wider than the feeds 56 so that the feeds 56 can traverse wind onto the hubs 24 in a side-by-side manner to form, as the multiple rolls 22, spools of mono-axially oriented draw tape 24, i.e., like spools of thread (see FIGS. 1 and 2). In another arrangement, the feeds 56 wind onto the hubs 24 in a continuous overlapping manner to form, as the multiple rolls 22, a set of pads or “pancakes” of mono-axially oriented draw tape 22, i.e., like roles of masking tape.

It should be understood that the use of the winding assembly 40 in the draw tape manufacturing system 20 enables multiple rolls 22 of draw tape to be created in a contiguous manner. Accordingly, there is no need for winding sheets into master rolls and, in a secondary procedure, subsequently unwinding the sheets, cutting the sheets into individual feeds and winding and splicing the feeds into pads or spools, as in the above-described conventional blown-film and multi-layer blown-film extrusion approaches. Moreover, the use of the winding assembly 40 in the system 20 is well-suited for making spools 22 having extremely long draw tape lengths with no weak points (e.g., with no splice points) since there is no winding and unwinding sheets (i.e., there are no master rolls) which limit the feed lengths. For example, each roll 22 of draw tape (see FIG. 1) can easily exceed 2,500 feet in length (e.g., 50,000 foot lengths, 100,000 foot lengths, etc.).

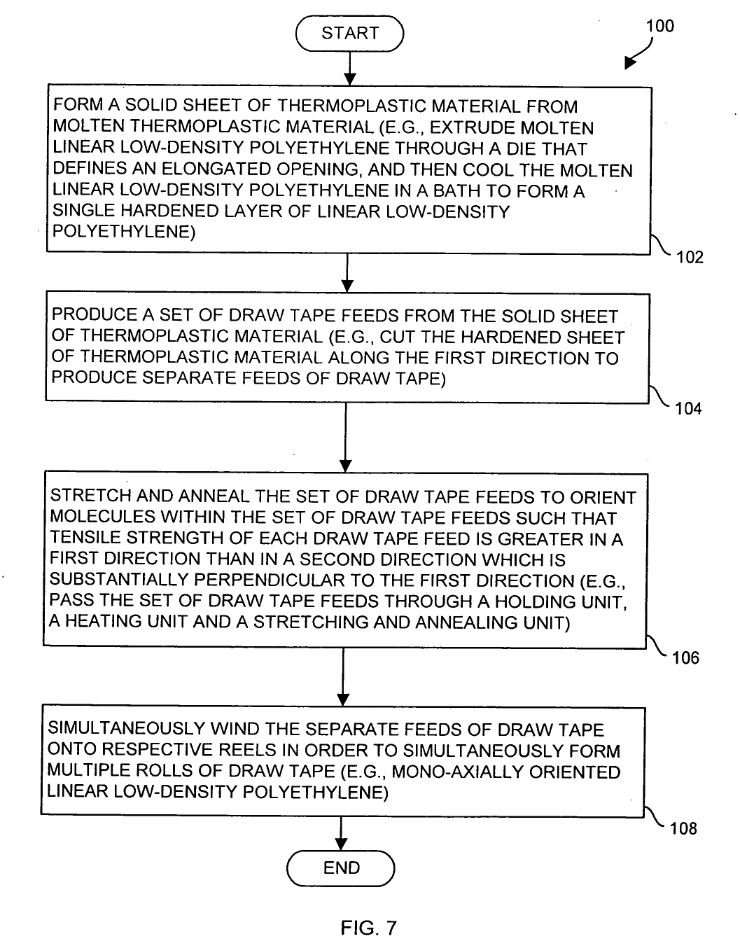

In one arrangement, the use of the die 60 of FIG. 3 in the front-end assembly 42 (also see the extruding die 32 of FIG. 1) enables the draw tape to consist of a single solid layer of LLDPE. Accordingly, the system 20 can provide a simpler and less expensive draw tape manufacturing process than that used in the earlier-described conventional multi-layer blown-film extrusion approach which involves passing both HDPE and lower-density material through separate channels and openings of a more-complex die in order to generate a multi-layer draw tape. Further details of the invention will now be provided with reference to FIG. 7.

FIG. 7 shows a procedure 100 which is performed by the mono-axially oriented draw tape manufacturing system 20. In step 102, the front-end assembly 42 (FIG. 1) forms the solid sheet 52 (FIG. 2) of thermoplastic material from molten thermoplastic material 50. In one arrangement, the front-end assembly 42 receives, as the thermoplastic material 44, LLDPE in a pellet form. The extruder 30 extrudes the thermoplastic material through the extruding die 32 which defines an elongated opening, e.g., a flat or straight-shaped aperture (also see the die 60 in FIG. 3), to form a molten sheet 50 of thermoplastic material. The cooling assembly 34 cools the molten sheet 50 (e.g., LLDPE) in a bath to form a solid sheet 52 consisting of a single-layer of thermoplastic material.

In step 104, the cutting assembly 36 produces a set of draw tape feeds 54 from the solid sheet 52 of thermoplastic material. In particular, the cutting assembly 36 cuts the solid sheet 52 along the lengthwise direction (i.e., the direction of movement of the solid sheet 52) to produce separate feeds 54 of draw tape.

In step 106, the orientating assembly 38 stretches and anneals the set of draw tape feeds 54 to orient molecules within the set of draw tape feeds 54 such that the tensile strength of each draw tape feed 54 is greater in the lengthwise direction than in the widthwise direction which is substantially perpendicular to the lengthwise direction. In particular, the set of draw tape feeds 54 pass through a rotating holding unit 80-A (see FIG. 4), a heating unit 80-B that raises the temperature of the feeds 54, and a stretching unit 80-C that rotates faster than the holding unit. The combination of elevated temperatures and faster speeds stretches and orients the feeds 54. The feeds next pass over a set of annealing rollers 80-D that use various speeds and temperatures to permanently set the orientation of the draw tape feeds 54.

In step 108, the winding assembly 40 simultaneously winds the feeds 56 of draw tape exiting the orientating assembly 38 onto respective hubs 22 in order to simultaneously form multiple rolls 22 of draw tape (also see FIGS. 1 and 2). In one arrangement, each roll 22 of draw tape includes a feed of single-layer mono-axially oriented LLDPE. It should be understood that even with the use of LLDPE, the draw tape can be manufactured to have equal or greater tensile strength in a particular direction (e.g., the lengthwise direction along the draw tape feed) than conventional draw tape that includes HDPE (e.g., a bi-axially oriented draw tape made from a 20/80 blend of LLDPE and HDPE). As a result, the draw tape feeds are extremely strong in the particular direction and are well-suited for use in draw tape bags.

Furthermore, it should be understood that steps 100 through 108 can be performed in a continuous manner as a set of ongoing steps so that each feed 56 is essentially unlimited in length. That is, as long as the system 20 continues operating, there is no limit to the length of each feed 56 of mono-axially oriented draw tape. As a result, extremely long lengths of draw tape can be produced, and such lengths can be provided to draw tape bag manufacturers enabling the draw tape bag manufacturers to continuously operate their production lines without any tape splices which otherwise would become possible points of failure and waste.

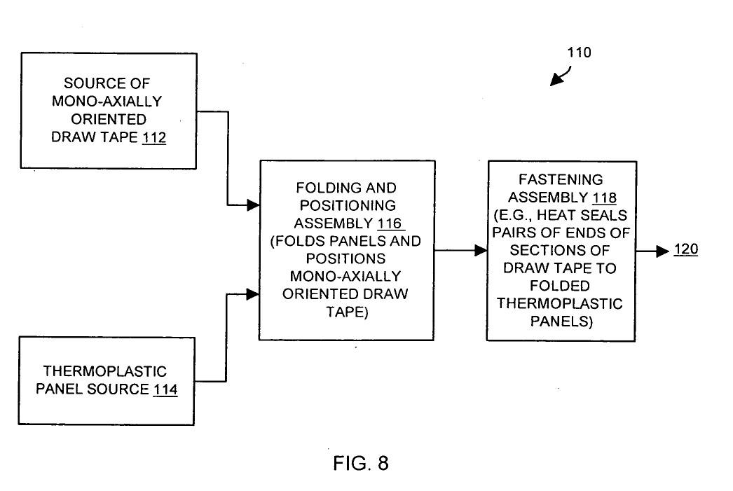

It should be further understood that manufacturing the mono-axially oriented draw tape using the system 20 is generally less expensive and less complex than manufacturing draw tape using the conventional blown-film approach and the conventional multi-layer blown-film extrusion approach. In particular, the continuous nature of the system 20 and the method 100 provides an advantageous cost effective use of resources (e.g., no winding and unwinding sheets). Further details of the invention will now be provided with reference to FIGS. 8-10.

FIG. 8 shows a block diagram of a draw tape bag manufacturing system 110 which is suitable for use by the invention. The draw tape bag manufacturing system 110 includes a source of mono-axially oriented draw tape 112, a thermoplastic panel source 114, a folding and positioning assembly 116, and a fastening assembly 118. The thermoplastic panel source 114 provides sets of thermoplastic panels to the folding and positioning assembly 116 (e.g., separate sets of thermoplastic panels, a long feed of thermoplastic material that can later be cut into sets of thermoplastic panels, partially cut sets of thermoplastic panels which remain at least partially attached to each other in a series, etc.). The source of mono-axially oriented draw tape 112 provides mono-axially oriented draw tape strips to the folding and positioning assembly 116 (e.g., separate draw tape strips, long feeds of draw tape that can later be cut into separate draw tape strips, partially cut draw tape strips which remain at least partially attached to each other in a series, etc.).

In one arrangement, the source of mono-axially oriented draw tape 112 operates simultaneously with the other components 114, 116, 118 thus avoiding a need to wind and unwind the draw tape prior to its use in draw tape bags. The earlier-described mono-axially oriented draw tape manufacturing system 20 (FIG. 1), e.g., without the winding assembly 40 or with the winding assembly 40 so that the generated rolls 22 of draw tape can be transferred to another location for use in draw tape bags, is suitable for use as the source of single-layer mono-axially oriented draw tape 112.

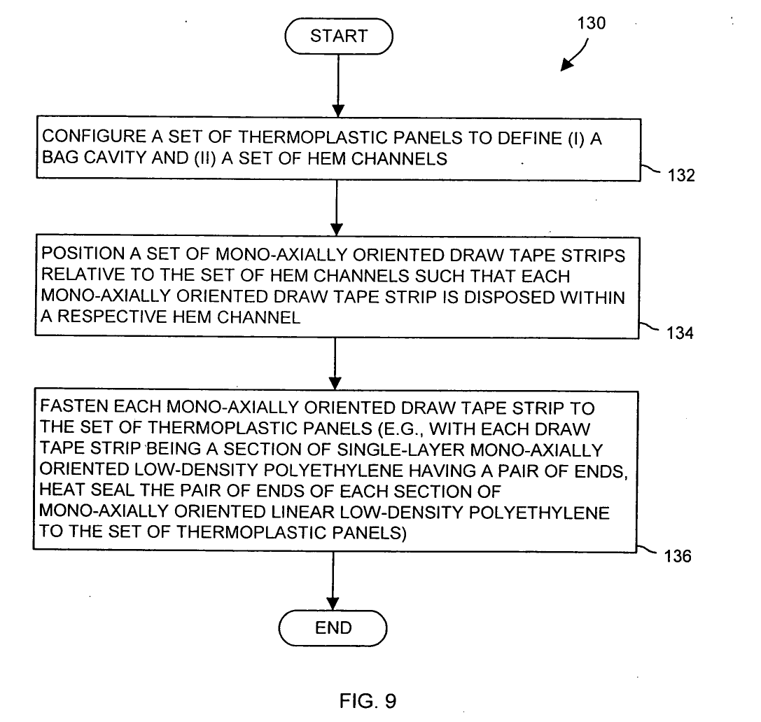

FIG. 9 shows a procedure 130 performed by the draw tape bag manufacturing system 110. In step 132, the folding and positioning assembly 116 receives a set of mono-axially oriented draw tape strips from the source of mono-axially oriented draw tape 112, and a set of thermoplastic panels from the thermoplastic panel source 114. The folding and positioning assembly 116 then configures a set of thermoplastic panels to define (i) a bag cavity and a (ii) set of hem channels. Optionally, the folding and positioning assembly 116 can perform additional operations as this point such as cutting holes in the hem channels to enable a user to later access draw tape through the holes.

In step 134, the folding and positioning assembly 116 positions the set of mono-axially oriented draw tape strips relative to the set of hem channels such that each mono-axially oriented draw tape strip is disposed within a respective hem channel. In one arrangement, the mono-axially oriented draw tape strips consist of single-layer mono-axially oriented LLDPE.

In step 136, the fastening assembly 118 and then fastens each mono-axially oriented draw tape strip to the set of thermoplastic panels. In particular, the fastening assembly 118 heat seals pairs of ends of the draw tape strips to the set of thermoplastic panels forming the bag cavity and a set of hem channels thus forming a draw tape bag (e.g., using a stamp/press process, using a rotating stamping process, etc.). The draw tape bag manufacturing system 110 can include additional stages such as the winding stage which winds multiple draw tape bags (e.g., slightly attached along a perforated edge) onto a reel for subsequent storage and/or shipping.

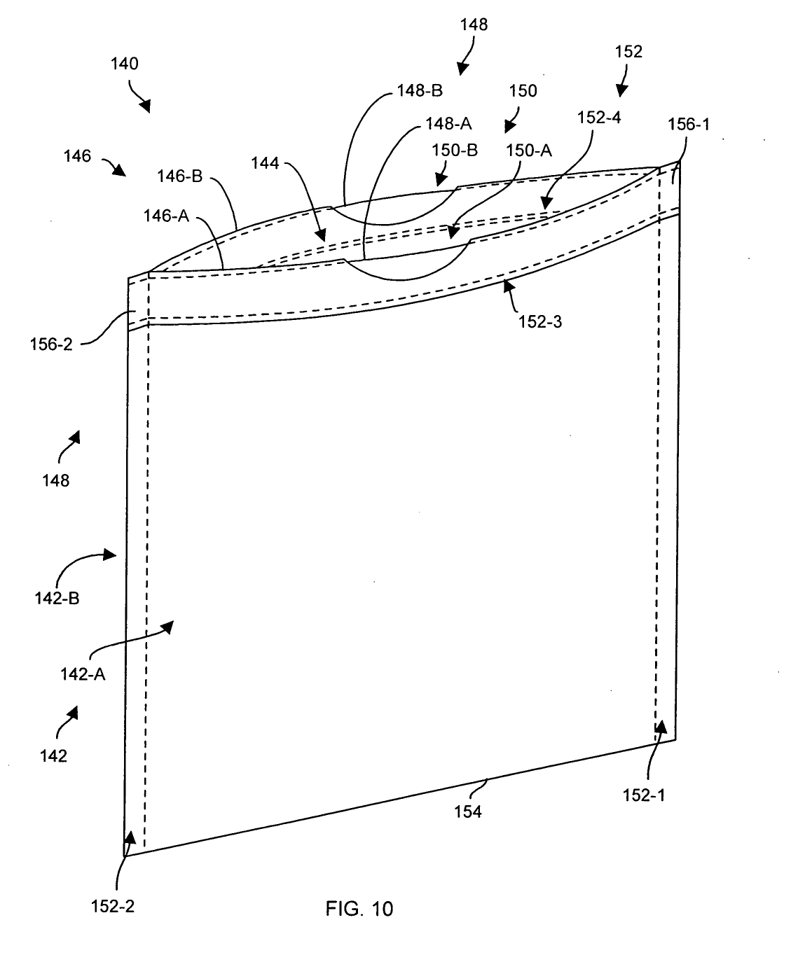

FIG. 10 is a perspective view of a draw tape bag 140 (e.g., a trash bag, a reusable plastic bag, a shopping bag, etc.) produced by the draw tape bag manufacturing system 110. The draw tape bag 140 includes a set of thermoplastic panels 142 which are configured to define a bag cavity 144 and a set of hem channels 146 (e.g., tubular hems). In particular, a thermoplastic panel 142-A forms one side of the bag 140 and a hem channel 146-A, and a thermoplastic panel 142-B forms another side of the bad 140 and a hem channel 146-B.

The draw tape bag 140 further includes a set of mono-axially oriented draw tape strips 148 which reside within the set of hem channels 146. In particular, a mono-axially oriented draw tape strip 148-A resides in the hem channel 146-A, and a mono-axially oriented draw tape strip 148-B resides in the hem channel 146-B.

Each thermoplastic panel 142 defines a hole 150 in the hem channel 146 of that panel. In particular, the thermoplastic panel 142-A defines a hole 150-A in the hem channel 146-A. Similarly, the thermoplastic panel 142-B defines a hole 150-B in the hem channel 146-B. The holes 152 permit a user to access the draw tape strips 148 to close the bag 140 and/or carry the bag 140.

It should be understood that the bag 140 includes a number of heat seals 152 which hold particular parts of the bag 140 together. In particular, the bag 140 includes heat seals 152-1, 152-2 along the sides of the thermoplastic panels 142-A, 142-B so that the panels 142-A, 142-B attach along three sides to form the bag cavity 144 (the thermoplastic panels 142 being attached and folded over each other along one side 154 of the three sides). Additionally, the bag 140 includes heat seals 152-3, 152-4 to form the hem channels 146-A, 146-B.

It should be further understood that each draw tape strip 148-A, 148-B is fastened to the set of thermoplastic panels 142-A, 142-B by a heat seal. In particular, one end of each draw tape strip 148-A, 148-B is heat sealed to one edge of the bag 140 along the heat seal 152-1 at a location 156-1, and another end of each draw tape strip 148-A, 148-B is heat sealed to another edge of the bag 140 along the heat seal 152-2 at a location 156-2.

In one arrangement, each draw tape strip 148-A, 148-B is a section of single-layer mono-axially oriented LLDPE. Since LLDPE has a lower melting point than HDPE or a typical blend of HDPE and lower-density material, less heat and time is required to heat seal the draw tape strips 148-A, 148-B. Accordingly, the cost of manufacturing draw tape bags 140 using such draw tape strips 148-A, 148-B is lower than that for manufacturing draw tape bags using HDPE (e.g., a conventional multi-layer draw tape having an HDPE core, a conventional draw tape made from a 20/80 blend of LLDPE and HDPE, etc.).

As described above, embodiments of the invention are directed to techniques for making mono-axially oriented draw tape which is useful in certain applications such as in draw tape bags 140, the draw tape bags 140 themselves, and related processes, products and components. Such techniques involve stretching and annealing a feed 54 of draw tape to orient molecules within the draw tape feed 54 such that the tensile strength of the draw tape feed 54 is greater in a particular direction (e.g., a direction along the draw tape feed). Accordingly, a manufacturer can use certain materials (e.g., LLDPE) to fabricate a draw tape which requires less heat and time to fasten to thermoplastic panels than typical draw tapes (e.g., a single-layer draw tape consisting of a blend of 20% LLDPE and 80% HDPE, a multi-layer draw tape having an HDPE core, etc.) when manufacturing the draw tape bag 140, but which still provides strength that is equal to or greater than a conventional draw tape in a particular direction (e.g., the direction along the draw tape feed). Additionally, the process for making the draw tape can be performed in a contiguous manner thus enabling production of essentially unlimited lengths of draw tape thus enabling the manufacture of draw tape bags 140 without any tape splices which otherwise would pose possible points of failure. The features of the invention, as described above, may be employed in draw tape manufacturing systems, devices, products and methods for making mono-axially oriented draw tape, as well as various systems, products (e.g., draw tape bags) and methods which use such tape, such as those of Film X, Inc. of Dayville, Conn.

While this invention has been particularly shown and described with references to preferred embodiments thereof, it will be understood by those skilled in the art that various changes in form and details may be made therein without departing from the spirit and scope of the invention as defined by the appended claims.

For example, it should be understood that various stages of the mono-axially oriented draw tape manufacturing system 20 were provided by way of example only. One or more of the stages can be omitted, and one or more other stages can be added. For instance, the cutting assembly 36 is not required to make a mono-axially oriented film for draw tape, but is useful in some applications such as when winding long lengths of draw tape without splices. As another example, a step of color incorporation can be performed by the front-end assembly 42 (e.g., during the drying/mixing stage, see the drying/mixing assembly 28 of FIG. 1) in order to provide the mono-axially oriented draw tape with a particular color (e.g., yellow, red, etc.). As yet another example, a step of slip agent incorporation can be performed by the front-end assembly 42 (e.g., during the mixing stage) in order to provide the mono-axially oriented draw tape with a particular coefficient of friction.

Additionally, it should be understood that the draw tape manufacturing system 20 was described as providing draw tape consisting of single-layer LLDPE by way of example only. In other arrangements, the draw tape can include other materials such as a percentage of HDPE for applications requiring enhanced strength, LDPE, EVA, or other thermoplastic polymers, etc.

Furthermore, it should be understood that the draw tape made by the manufacturing system 20 can undergo additional processes beyond the processes identified above. For example, the draw tape can be stamped or printed with designs (e.g., trademarks, symbols, logos, etc.) or treated (e.g., sprayed or coated with a low friction agent) in intermediate stages (e.g., between the orientating assembly 38 and the winding assembly 40) or in subsequent stages (e.g., just prior to installation in hem channels when manufacturing a draw tape bag 140).

Additionally, it should be understood that the ratio of 2.8 to 1.0 of lengths between the draw tape feeds 56 exiting the orientating assembly 38 and the draw tape feeds 54 entering the orientating assembly 38 was provided by way of example only. In other arrangements, the ratio is different (e.g., anywhere in a range of 1.05 to 1.0 through 10.0 to 1.0).

Furthermore, it should be understood that the draw tape bag manufacturing system 110 was described as including the source of mono-axially oriented draw tape 112 by way of example only. In other arrangements, the draw tape bag manufacturing system 110 includes other draw tape sources such as sources which utilized a blown-film approach or a multi-layer extrusion approach, but that operate in a contiguous manner to provide essentially unlimited feeds of draw tape without winding and unwinding the draw tape prior to its use in draw tape bags.

What is claimed is:

1. A method for making mono-axially oriented draw tape, the method comprising the steps of:
forming a solid sheet of thermoplastic material from molten thermoplastic material;
producing a set of draw tape feeds from the solid sheet of thermoplastic material; and
stretching and annealing the set of draw tape feeds to orient molecules within the set of draw tape feeds such that tensile strength of each draw tape feed is greater in a first direction than in a second direction which is substantially perpendicular to the first direction.

2. The method of claim 1 wherein the step of stretching and annealing includes the step of:
passing the set of draw tape feeds around a series of rotating temperature-controlled rollers to stretch and anneal the set of draw tape feeds, wherein the series of rotating temperature-controlled rollers includes a first roller which is configured to rotate at a first rate and have a first temperature, and a second roller which is configured to rotate at a second rate that is different than the first rate and have a second temperature that is different than the first temperature.

3. The method of claim 1 wherein the step of producing the set of draw tape feeds includes the step of:
cutting the solid sheet of thermoplastic material along the first direction to produce, as the set of draw tape feeds, separate feeds of draw tape.

4. The method of claim 3, further comprising the step of:
after the step of stretching and annealing, simultaneously winding the separate feeds of draw tape onto respective hubs in order to simultaneously form multiple rolls of draw tape.

5. The method of claim 1 wherein the molten thermoplastic material includes molten linear low-density polyethylene, and wherein the step of forming the hardened sheet of thermoplastic material includes the step of:
cooling the molten linear low-density polyethylene in a bath in order to form, as the solid sheet of thermoplastic material, a single solid layer of linear low-density polyethylene.

6. The method of claim 5 wherein the step of forming the solid sheet of thermoplastic material further includes the step of:
prior to the step of cooling, extruding the molten linear low-density polyethylene through a die that defines an elongated opening.

7. Mono-axially oriented draw tape made by a method comprising the steps of:
forming a solid sheet of thermoplastic material from molten thermoplastic material;
producing a set of draw tape feeds from the solid sheet of thermoplastic material; and
stretching and annealing the set of draw tape feeds to orient molecules within the set of draw tape feeds such that tensile strength of each draw tape feed is greater in a first direction than in a second direction which is substantially perpendicular to the first direction.

8. The mono-axially oriented draw tape of claim 7 wherein the step of stretching and annealing includes the step of:
passing the set of draw tape feeds around a series of rotating temperature-controlled rollers to stretch and anneal the set of draw tape feeds, wherein the series of rotating temperature-controlled rollers includes a first roller which is configured to rotate at a first rate and have a first temperature, and a second roller which is configured to rotate at a second rate that is different than the first rate and have a second temperature that is different than the first temperature.

9. The mono-axially oriented draw tape of claim 7 wherein the step of producing the set of draw tape feeds includes the step of:
cutting the solid sheet of thermoplastic material along the first direction to produce, as the set of draw tape feeds, separate feeds of draw tape.

10. The mono-axially oriented draw tape of claim 8 wherein the method further comprises the step of:
after the step of stretching and annealing, simultaneously winding the separate feeds of draw tape onto respective hubs in order to simultaneously form multiple rolls of draw tape.

11. The mono-axially oriented draw tape of claim 7 wherein the molten thermoplastic material includes molten linear low-density polyethylene, and wherein the step of forming the solid sheet of thermoplastic material includes the step of:
cooling the molten linear low-density polyethylene in a bath in order to form, as the solid sheet of thermoplastic material, a single solid layer of linear low-density polyethylene.

12. The mono-axially oriented draw tape of claim 11 wherein the step of forming the solid sheet of thermoplastic material further includes the step of:
prior to the step of cooling, extruding the molten linear low-density polyethylene through a die that defines an elongated opening.

13. A system for making mono-axially oriented draw tape, comprising:
a front-end assembly that is configured to form a solid sheet of thermoplastic material from molten thermoplastic material;
an intermediate assembly, coupled to the front-end assembly, that is configured to produce a set of draw tape feeds from the solid sheet of thermoplastic material; and
an orientating assembly, coupled to the intermediate assembly, that is configured to stretch and anneal the set of draw tape feeds to orient molecules within the set of draw tape feeds such that tensile strength of each draw tape feed is greater in a first direction than in a second direction which is substantially perpendicular to the first direction.

14. The system of claim 13 wherein the orientating assembly includes a series of rotating temperature-controlled rollers which are configured to stretch and anneal the set of draw tape feeds, wherein the series of rotating temperature-controlled rollers includes a first roller which is configured to rotate at a first rate and have a first temperature, and a second roller which is configured to rotate at a second rate that is different than the first rate and have a second temperature that is different than the first temperature.

15. The system of claim 13 wherein intermediate assembly includes:
a cutting assembly that is configured to cut the solid sheet of thermoplastic material along the first direction to produce, as the set of draw tape feeds, separate feeds of draw tape.

16. The system of claim 14, further comprising:
a winding assembly, coupled to the orientating assembly, that is configured to simultaneously wind the separate feeds of draw tape onto respective hubs in order to simultaneously form multiple rolls of draw tape.

17. The system of claim 13 wherein the molten thermoplastic material includes: molten linear low-density polyethylene, and wherein the front-end assembly includes:
a bath assembly that is configured to cool the molten linear low-density polyethylene in order to form, as the solid sheet of thermoplastic material, a single solid layer of linear low-density polyethylene.

18. The system of claim 16 wherein the front-end assembly further includes:
a extruder coupled to the bath assembly, wherein the extruder includes a die that defines an elongated opening, and wherein the extruder is configured to extrude the molten linear low-density polyethylene through the die.

19. A method for making a draw tape bag, the method comprising the steps of:
configuring a set of thermoplastic panels to define (i) a bag cavity and (ii) a set of hem channels;
positioning a set of mono-axially oriented draw tape strips relative to the set of hem channels such that each mono-axially oriented draw tape strip is disposed within a respective hem channel; and
fastening each mono-axially oriented draw tape strip to the set of thermoplastic panels.

20. The method of claim 19 wherein each draw tape strip is a section of single-layer mono-axially oriented linear low-density polyethylene having a pair of ends, and wherein the step of fastening includes the step of:
heat sealing the pair of ends of each strip of single-layer mono-axially oriented linear low-density polyethylene to the set of thermoplastic panels.

21. A draw tape bag, comprising:
a set of thermoplastic panels which is configured to define (i) a bag cavity and (ii) a set of hem channels; and
a set of mono-axially oriented draw tape strips, wherein each mono-axially oriented draw tape strip is disposed within a respective hem channel, and wherein each mono-axially oriented draw tape strip fastens to the set of thermoplastic panels.

22. The draw tape bag of claim 21 wherein each draw tape strip is a section of single-layer mono-axially oriented linear low-density polyethylene having a pair of ends which is heat sealed to the set of thermoplastic panels.

23. A system for making a draw tape bag, comprising:
a folding and positioning assembly that (i) configures a set of thermoplastic panels to define a bag cavity and a set of hem channels, and (ii) positions a set of mono-axially oriented draw tape strips relative to the set of hem channels such that each mono-axially oriented draw tape strip is disposed within a respective hem channel; and
a fastening assembly, coupled to the folding and positioning assembly, that fastens each mono-axially oriented draw tape strip to the set of thermoplastic panels.

24. The system of claim 23 wherein each draw tape strip is a section of single-layer mono-axially oriented linear low-density polyethylene having a pair of ends, and wherein the fastening assembly is configured to heat seal the pair of ends of each section of single-layer mono-axially oriented linear low-density polyethylene to the set of thermoplastic panels.
